(19) United States
(12) Patent Application Publication
(10) Pub. No.: US 2008/0117627 A1
(43) Pub. Date: May 22, 2008

(54) Adjustable lighting device

(75) Inventors: Ying-Tsung Lu, Hsinchu Hsien (TW); Huang-Chen Guo, Hsinchu Hsien (TW)

Correspondence Address: BIRCH STEWART KOLASCH & BIRCH, PO BOX 747, FALLS CHURCH, VA, 22040-0747, US

(73) Assignee: Industrial Technology Research Institute, Hsinchu Hsien (TW)

(21) Appl. No.: 11/889,222

(22) Filed: Aug. 9, 2007

(30) Foreign Application Priority Data
Nov. 17, 2006 (TW) 095142522

(51) Int. Cl. F21V 9/10; F21V 29/00; F21V 7/00

(52) U.S. Cl. 362/231; 362/294; 362/296

(57) ABSTRACT

An adjustable lighting device for use in an adjustable ambient lighting system is proposed, which includes a reflection element having at least a reflection portion and an opening, a light emitting unit disposed in the reflection element so as to provide light to be reflected by the reflection portion, and a diffusion element for sealing the opening so as to receive and disperse the light reflected by the reflection portion, thereby enabling efficient adjustment of the color of light sources, uniform scattering of the light to the surroundings, and creation of various lighting scenarios.

The patent or application file contains at least one drawing executed in color. Copies of this patent or patent application publication with color drawing(s) will be provided by the office upon request and payment of the necessary fee.

### BACKGROUND OF THE INVENTION

1. Field of the Invention

The present invention relates to adjustable lighting devices, and more particularly, to an adjustable lighting device for use in an adjustable ambient lighting system.

2. Description of the Prior Art

With advances in technology, electronic products nowadays are multimedia-oriented and technically based on a combination of information technology, consumer behavior, and communications. In this regard, lighting devices are becoming a more common focus of attention of consumers, because of the wide use of sophisticated parts and components of lighting devices. Knowing the effect of light on biorhythms, researchers specialized in lighting technology are not only engaged in research and development of functional lamps but also devoted to that of scenario-based lighting systems.

Existing lighting devices that employ adjustable ambient lighting (scenario-based lighting) technology, such as a monitor, are controlled in two ways, namely emotion-dependent and color-dependent. As disclosed in U.S. published Patent Application No. 20060058925, color-dependent lighting control involves installing a plurality of light sources in a room, allowing a monitor to receive signals comprising TV signals and brightness/color-switching signals, and setting ambient light configuration options by means of a configuration device of the system.

Nonetheless, the aforesaid lighting system is high-energy-consuming and space-demanding. To avoid mutual interference from the plurality of light sources and control light emitting efficiency, relative positions of the light sources and other related components have to be specially designed. Hence, the drawbacks of the aforesaid lighting system are, namely complicated structures, compromised indoor designs, and users being incapable of adjusting the relative positions of the light sources and other related components.

Another embodiment of the aforesaid adjustable ambient lighting system discloses a thin TV set equipped with a scenario-based lighting module, wherein the scenario-based lighting module comprises at least three cold cathode fluorescent lamps (CCFLs of the three primary colors RGB) collectively functioning as the full-color backlight source for liquid crystal display (LCD). The three cold cathode fluorescent lamps are maskably disposed inside a symmetrically-built reflection mask. A lenticular lens lying in a path of the light emitted by the cold cathode fluorescent lamps is disposed on an outer surface of the reflection mask. In so doing, light is projected from behind the screen of the thin TV set, and thus brightness and color are automatically adjusted in accordance with pictures displayed on the screen.

The aforesaid embodiment of an adjustable ambient lighting system has its own drawbacks: the CCFLs of the embodiment are expensive, bulky and in want of flexibility in design. The aforesaid embodiment of an adjustable ambient lighting system is further disadvantaged for the reason that a CCFL is a linear light source with poor light field uniformity. Last but not least, given strict alignment requirements, a minor error in the position of a lenticular lens always brings about a decrease in light yield, thereby preventing adjustment of brightness and color.

Accordingly, an issue calling for urgent solution involves developing a scenario-based lighting system for adjusting color of light sources readily and creating various lighting scenarios.

### SUMMARY OF THE INVENTION

The present invention provides an adjustable lighting device for adjusting color of light sources readily and creating various lighting scenarios.

The present invention may also provide an adjustable lighting device for enhancing light field uniformity and light color mixing.

The present invention may also provide an adjustable lighting device requiring no alignment of light sources.

The present invention may also provide an adjustable lighting device of reduced size.

The present invention may also provide an adjustable lighting device flexible in design so as to meet custom-made needs.

The present invention provides an adjustable lighting device for use in an adjustable ambient lighting system. The adjustable lighting device comprises: a reflection element having at least one reflection portion and one opening; at least a light emitting unit disposed in the reflection element so as to provide light to be reflected from the reflection portion; and a diffusion element for sealing the opening so as to receive and disperse the light reflected from the reflection portion, thereby allowing the light to be uniformly scattered to the surroundings.

Preferably, the reflection element is plate-shaped and made of highly reflective material. For instance, the reflection element can be either a plate particle made of metal or a plastic plate on which a metallic layer is formed by depositing or sputtering technology. The reflection portion is formed by folding a predetermined part of the reflection element, allowing an included angle θ to be formed between the reflection portion and the reflection element. The included angle θ ranges between 1 and 90 degrees. The light emitting unit comprises a light emitting diode (LED) capable of emitting red, green, blue, any other single color, and white light. Alternatively, the light emitting unit may comprise a plurality of light emitting diodes capable of emitting red, green, blue, and any other single color light. Structural parameters for designing the diffusion element are, for example, thickness, anti-glareness, transmittance, and a number of diffusion surfaces. In addition, the light emitting unit can be a point light source or an area light source.

In a preferred embodiment, on a surface of the diffusion element that backwardly faces the reflection element an uneven region is formed. The uneven region is a region of the surface of the diffusion element that is distributed with a plurality of protrusions or roughened.

In comparison with the prior art, the adjustable lighting device of the present invention provides a simple structure capable of changing the color of a light source effectively and create various lighting scenarios. It thus can solve problems that, for instance, the conventional structure is so complicated as to compromise indoor design and prevents users from adjusting the arrangement position by themselves. The present invention also provides uniformity of light field and increase of color as a result of multi-path reflection feature by means of the reflection element. Furthermore, the present invention spares the use of a lens, thereby experiencing no alignment problem that is otherwise common in the prior art. Lastly, an adjustable ambient lighting system equipped with the adjustable lighting device of the present invention allows for variations in the structure of the adjustable lighting device in accordance with the characteristics and requirements of the adjustable ambient lighting system and the related electronic products, and thus the present invention provides flexibility in design and meets custom-made needs.

### BRIEF DESCRIPTION OF THE DRAWINGS

FIG. 1 is a schematic view showing the structure of the first embodiment of an adjustable lighting device of the present invention;

FIG. 2 is a schematic view showing the distribution of light field of an adjustable lighting device used in an electronic product in accordance with the present invention as revealed in optical simulation;

FIG. 3 is a schematic view showing the distribution of light field of an adjustable lighting device used in an electronic product in accordance with the present invention as revealed in practice;

FIG. 4 is a schematic view showing the structure of the second embodiment of an adjustable lighting device of the present invention;

FIG. 5 is a side view showing the structure of the third embodiment of an adjustable lighting device of the present invention; and

FIG. 6 is a schematic view showing the structure of a variant embodiment of an adjustable lighting device of the present invention.

### DETAILED DESCRIPTION OF THE PREFERRED EMBODIMENTS

The following specific embodiments are provided to illustrate the present invention. Others ordinarily skilled in the art can readily gain an insight into other advantages and features of the present invention based on the contents disclosed in this specification.

A point to note is that an adjustable lighting device of the present invention is provided to be used in an adjustable ambient lighting system; accordingly, the adjustable ambient lighting system may at least comprise the adjustable lighting device and software for controlling the adjustable lighting device. The adjustable ambient lighting system can be applied to electronic products, such as a monitor, TV set, cellular phone, digital camera, PDA, game boy, computer screen, advertising signboard, and etc. The following embodiments are exemplified by a TV set.

In addition to the aforesaid electronic products, the present invention is applicable to any other electronic products capable of creating lighting scenarios. The software for controlling the adjustable lighting device in the adjustable ambient lighting system can be an appropriate one disclosed in the known prior art. Therefore, only structures directly related to the present invention are shown in the drawings for brevity. Also, the present invention includes, but is not limited to, the electronic product structures of the following preferred embodiments.

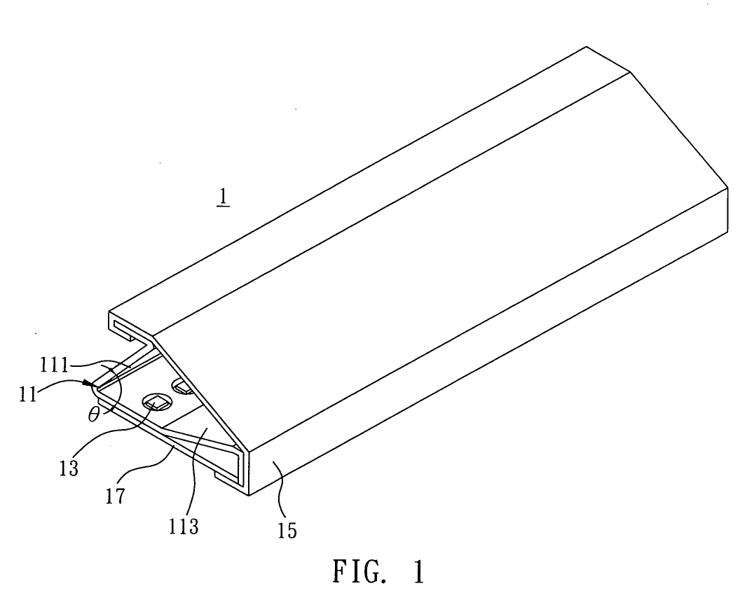

FIGS. 1-3 are schematic views showing the first embodiment of an adjustable lighting device in accordance with the present invention.

Referring to FIG. 1, which is a schematic view showing the structure of the first embodiment of an adjustable lighting device of the present invention, an adjustable lighting device 1 comprises a reflection element 11, a light emitting unit 13 disposed in the reflection element 11, and a diffusion element 15 coupled to the reflection element 11.

The reflection element 11 comprises at least a reflection portion 111 and an opening 113. In this embodiment, the reflection element 11 is plate-shaped, metallic and having a V-shaped cross-section, and, alternatively, the reflection element 11 can also be fabricated by depositing or sputtering a metallic material such as silver or aluminum on a plastic plate. In other words, any highly reflective materials are applicable to the fabrication of the reflection element 11. The reflection portion 111 is formed by folding a predetermined part of the reflection element 11, allowing an included angle θ to be formed between the reflection element 11 and the reflection portion 11. The included angleθ ranges between 1 and 90 degrees. A point to note is that, in this embodiment, the reflection element 11 is formed with merely a reflection portion 111; however, a plurality of reflection portions 111 may be provided to the reflection element 11, allowing color mixing to increase as a result of multi-path reflection contributed by the plurality of reflection portions 111.

The light emitting unit 13 is disposed in the reflection element 11 so as to provide the light to be reflected by the reflection portion 111. In this embodiment, the light emitting unit 13 corresponds in position to the reflection portion 111 and comprises a durable, environment-friendly light emitting diode (LED) of a single light color selected from the group consisting of red, green, blue, white and other color. Alignment pattern and quantity of the light emitting diodes are not to be limited by the present invention, as they can be readily modified, when in necessary, by persons of ordinary skill in the art.

Alternately, the light emitting unit 13 may be composed of a plurality of light emitting diodes of different light colors reflected from red, green, blue, and other color, and the light emitting diodes may be alternately aligned in the reflection element 11. The alternate alignment can be of either a regular pattern or an irregular pattern. Inasmuch as the light emitting unit 13 corresponds in position to the reflection portion 111, the light emitting unit 13 is good as long as the light emitting unit 13 emits light that is reflected from the reflection portion 111 and well-mixed to achieve uniformity of light field. The light emitting unit 13 can be a point light source or an area light source, thereby requiring no special light source alignment.

The diffusion element 15 is managed to seal the opening 113 so as to distribute the light and allow the light to be uniformly scattered to the surroundings. In this embodiment, a diffusion element 15 is a diffusion board that is flat and serves a diffusion purpose. The diffusion element 15 is coupled to the reflection element 11 so as to allow the light to be uniformly scattered to the surroundings by diffusion. In so doing, not only are a user's eyes protected against exposure to intense light, but the light emitted is much more uniformly distributed, thereby striking a balance between eye protection and good product design. The diffusion element 15 is in a plate form or a coating made of polycarbonate (PC) doped with diffusant, a diffusion-enhancing material, composite diffusion-enhancing material with a brightness enhancement film function, or any other equivalent material.

A point to note is that diffusance achieved by the diffusion element 15 can be adjusted according to product requirement. For instance, consideration is given to structural parameters of the diffusion element 15, such as thickness, anti-glareness, transmittance, and a number of diffusion surface. It is also feasible to fabricate the diffusion element 15 in the form of a micro structure. The processing of the diffusion element 15 is conventional to persons of ordinary skill in the art and thereby is not reiterated herein.

The adjustable lighting device of the first embodiment further includes a base 17, which may be a transparent substrate, a transparent film, or other equivalent transparent component, coupled to the reflection element 11. The base 17 can also be a heat spreader for enhancing thermal conductivity of the adjustable lighting device of the present invention, so as to prevent reduction of light yield from taking place due to high thermal resistance. The base 17 is selectively coupled to a back side of the reflection element 11, and the reflection element 11 is formed with at least a receiving opening 115 for receiving at least a light emitting unit 13 formed on the base 17.

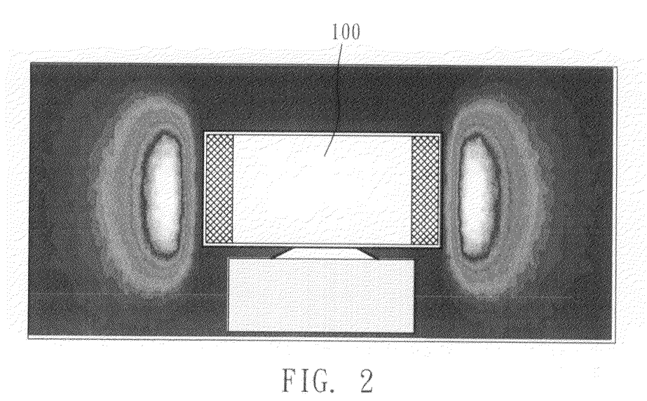

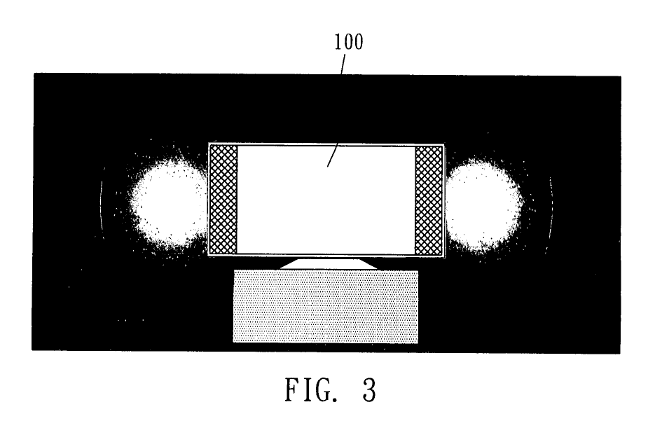

The reflection element 11 is capable of evenly diverting the light emitted from the light emitting unit 13 and blending the emitted light to obtain desired color, such that the diffusion element 15 can uniformly diffuse the light to the surroundings. As shown in FIG. 2, an optical simulation reveals a clearly visible, sharply contrasted light field of an adjustable ambient lighting system equipped with the adjustable lighting device 1 and applied to an electronic product 100, wherein the brightest area shown in the drawing indicates maximum light field intensity, and an outward decrease in brightness indicates an outward decrease in light field intensity. FIG. 3 is a schematic view showing the distribution of light field of the adjustable ambient lighting system having the adjustable lighting device 1 and applied to the electronic product 100 when implemented in practice. In view of FIG. 3, it can be clearly noticed that the experimental findings match the predicted results of the optical simulation.

As mentioned above, when the adjustable ambient lighting system is applied to the electronic product 100, the adjustable lighting device 1 is allowed to be mounted on the back side of the electronic product 100, so as to serve as a scenario-oriented light source. However, persons of ordinary skill in the art should also be well aware that the adjustable ambient lighting system can be installed inside the electronic product 100, provided that uniform scattering of light to the surroundings is achieved and scenario-oriented light can be emitted in response to on a primary background color of a picture displayed on the electronic product 100.

In comparison with the prior art, the adjustable lighting device of the present invention is simple in structure that makes the change of the color of a light source effective and capable of creating various lighting scenarios and enabling high uniformity of light field and color blending. The present invention discloses replacing a linear light source with a light emitting unit and sparing the use of a lenticular lens taught by the prior art, and thus the present invention is conducive to miniaturization, free of alignment problems, useful for cost reduction and enhancement of design flexibility. Accordingly, the present invention overcomes the drawbacks of the prior art.

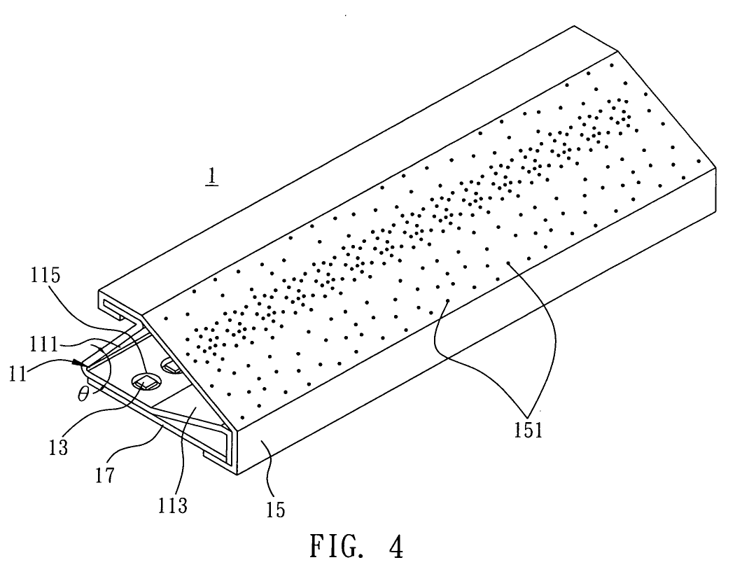

FIG. 4 is a schematic view showing the structure of the second embodiment of an adjustable lighting device of the present invention. Components of the second embodiment which are the same as those of the first embodiment are designated with same reference numerals and details thereof are not to be reiterated herein for the sake of brevity.

The second embodiment mainly differs from the first embodiment in a way that the diffusion element 15 of the second embodiment is formed with a plurality of micro-structures 151.

As shown in FIG. 4, a plurality of micro-structures 151 are formed on a surface of the diffusion element 15 opposite to the reflection element 11. The micro-structures 151 are in the form of protrusions protruded from the surface of the diffusion element 15. The protrusions can be either evenly or unevenly distributed on the surface of the diffusion element 15. The size of the protrusions also varies; for example, to achieve uniform brightness, the protrusions 151 close to the light emitting unit 13 are sparse and small, and those away from the light emitting unit 13 are dense and large. In so doing, intense light emitted from the light emitting unit 13 is scattered to a lesser extent, and weak light emitted by the light emitting unit 13 is scattered to a greater extent.

Persons of ordinary skill in the art are well aware that position, quantity, alignment pattern and size of the micro-structures 151 are not limited to which is disclosure in this embodiment.

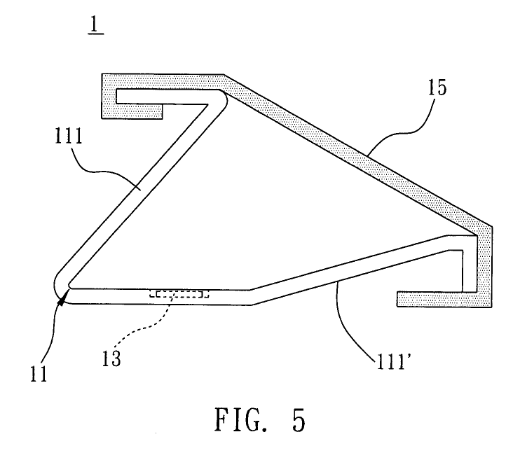

FIG. 5 is a side view showing the structure of the third embodiment of an adjustable lighting device of the present invention. Components of the third embodiment which are the same as those of the prior embodiment are designated with same reference numerals, and details thereof are not to be reiterated herein for the sake of brevity.

The third embodiment mainly differs from the prior embodiments in the way that there is no base coupled to the reflection element and the light emitting units in the reflection element are directly mounted on the reflection element.

As shown in FIG. 5, an adjustable lighting device 1 comprises a reflection element 11, a plurality of light emitting units 13 embeddedly disposed in the reflection element 11, and a diffusion element 15 is coupled to the reflection element 11. The reflection element 11 is formed with a groove for receiving the light emitting units 13. In this embodiment, the reflection element 11 is provided with two reflection portions 111 and 111′. With the provision of the two reflection portions 111 and 111′, the color mixing increases as a result of multi-path reflection. It should be understood that the reflection element 11 can be provided with more than two reflection portions, depending on the design and requirement.

In addition to the aforesaid embodiments, an adjustable lighting device of the present invention is subject to structural change. For instance, in addition to plate-shaped appearance, both the reflection element and the diffusion element can be a parabolic, curved, or other equivalent shape, and the modification may be made thereto, if appropriate. Also, the adjustable lighting device 1 can be employed along with an optical film.

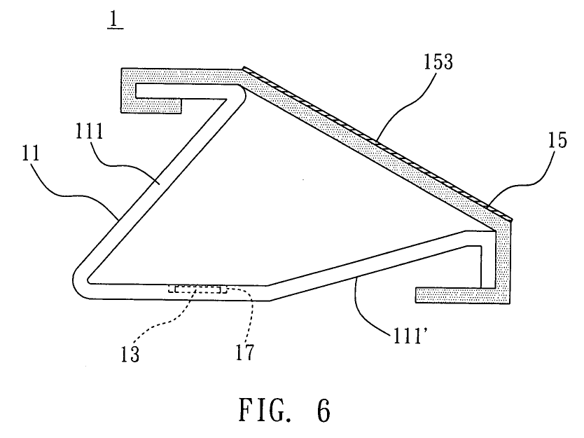

As shown in FIG. 6, the surface of the diffusion element 15 is further formed with an optical film 153 (or the optical film 153 is placed on the diffusion element 15), such as a protective film, diffusion-enhancing film, and brightness enhancement film (BEF), so as to increase brightness, uniformity of light, convergence of light, and brilliance of the emitted light. The optical film 153 can be a film or a thin strip. The optical film 153 can be integral with the diffusion element 15 to reduce cost and simplify the structure. As integrating the optical film 153 into the diffusion element 15 is conventional in technology to persons of ordinary skill in the art, detailed description thereto is omitted here.

Variations disclosed in the aforesaid embodiments can be swapped. For instance, the diffusion element of the third embodiment may comprise the micro-structures of the second embodiment as well. Persons of ordinary skill in the art can choose to dispose the adjustable lighting device above and below, and/or to the left and right of an electronic product. Lastly, given the various embodiments, the present invention is flexible in design and able to meet variable user needs.

The adjustable lighting device of the present invention enables effective change of the color of a light source, creation of various lighting scenarios, high uniformity of light field, and color mixing. Also, the present invention spares light source alignment, allows miniaturization, provides flexibility in design, and meets custom-made needs.

The aforesaid embodiments merely serve as the preferred embodiments of the present invention. They should not be construed as to limit the scope of the present invention. Hence, any other changes can be made in the present invention. It will be apparent to those ordinarily skilled in the art that all equivalent modifications or changes made, without departing from the spirit and the technical concepts disclosed by the present invention, should fall within the scope of the appended claims.

What is claimed is:

1. An adjustable lighting device for use in an adjustable ambient lighting system, comprising:
a reflection element having at least a reflection portion and an opening;
a light emitting unit disposed in the reflection element for emitting light toward the reflection portion; and
a diffusion element for sealing the opening and for receiving and dispersing light reflected from the reflection portion, allowing the light to be uniformly scattered to ambient environment.

2. The adjustable lighting device of claim 1, wherein the reflection element is plate-shaped.

3. The adjustable lighting device of claim 2, wherein the reflection element is made of metal.

4. The adjustable lighting device of claim 1, wherein the reflection element is fabricated by forming a metallic material on a plastic article via depositing or sputtering.

5. The adjustable lighting device of claim 1, wherein the reflection portion is integrally formed with the reflection element.

6. The adjustable lighting device of claim 5, wherein an included angle is formed between the reflection element and the reflection portion to range between 1 and 90 degrees.

7. The adjustable lighting device of claim 1, wherein the light emitting unit comprises at least a light emitting diode (LED).

8. The adjustable lighting device of claim 1, wherein the light emitting unit comprises a light emitting diode of a single light color selected from the group consisting of red, green, blue, and white color.

9. The adjustable lighting device of claim 1, wherein the light emitting unit comprises a plurality of light emitting diodes of multiple light colors selected from the group consisting of red, green, and blue.

10. The adjustable lighting device of claim 1, wherein the diffusion element has at least one structural parameter selected from the group consisting of thickness, anti-glareness, transmittance, and number of diffusion surfaces.

11. The adjustable lighting device of claim 1, wherein the diffusion element is formed with a plurality of micro-structures.

12. The adjustable lighting device of claim 11, wherein the micro-structures are formed on a surface of the diffusion element opposite to the reflection element.

13. The adjustable lighting device of claim 11, wherein the micro-structures are protrusions.

14. The adjustable lighting device of claim 1, wherein the reflection element is formed with a groove for receiving the light emitting unit.

15. The adjustable lighting device of claim 1, further comprising a base coupled to the reflection element, wherein the reflection element is formed with a plurality of receiving openings, allowing the light emitting unit to be mounted on the base via the receiving openings.

16. The adjustable lighting device of claim 15, wherein the base is transparent.

17. The adjustable lighting device of claim 15, wherein the base is a heat spreader.

18. The adjustable lighting device of claim 1, further comprising an optical film formed on a surface of the diffusion element.

19. The adjustable lighting device of claim 1, wherein the light emitting unit is one of a point light source and an area light source.
